(19) United States
(12) Patent Application Publication
(10) Pub. No.: US 2007/0195040 A1
(43) Pub. Date: Aug. 23, 2007

(54) Display device and driving apparatus thereof

(75) Inventors: Dae-Jin Park, Incheon-si (KR); Baek-Woon Lee, Yongin-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/703,623

(22) Filed: Feb. 6, 2007

(30) Foreign Application Priority Data
Feb. 7, 2006 (KR) 10-2006-0011458

(51) Int. Cl. G09G 3/36

(52) U.S. Cl. 345/89

(57) ABSTRACT

A display device includes a plurality of pixels, a signal controller converting current input image data of a first frequency into first and second output image data of a second frequency and outputting the first and second output image data, and a data driver converting respective output image data from the signal controller into corresponding analog data voltages and sequentially applying them to the pixels. The signal controller calculates a virtual position of a pixel where a virtual image is to be displayed as a virtual frame and virtual input image data based on previous input image data and the current input image data to generate modified current input image data, and converts the current input image data into first and second output image data based on the previous input image data and the modified current input image data. Accordingly, the virtual image is estimated by using the previous and current input image data and generating the output image data based on the virtual image to improve the display picture quality of a video image.

This application claims priority of Korean Patent Application No. 10-2006-0011458 filed on Feb. 7, 2006 together with all the benefits accruing therefrom under 35 U.S.C. §119 the contents of which are hereby incorporated by reference.

### FIELD OF THE INVENTION

The present invention relates to a display device and a driving apparatus thereof.

### DESCRIPTION OF RELATED ART

Generally, a liquid crystal display (“LCD”) includes a liquid crystal (“LC”) panel assembly including two panels, one lower panel provided with pixel electrodes and the other upper panel provided with common electrodes, and an LC layer exhibiting dielectric anisotropy between them. The pixel electrodes are arranged in a matrix and are connected to switching elements such as thin film transistors (“TFT”) that sequentially receive a data voltage on a row by row basis. The common electrode covers the entire surface of the upper panel and is supplied with a common voltage Vcom. From the circuit perspective, the pixel electrode, common electrode, and LC layer form an LC capacitor and the LC capacitor together with a switching element connected form a basic unit of a pixel.

In order to protect the LC layer from the deleterious effects of a uni-directional electric field, the polarity of the data voltage is reversed for each frame, for each row, or for each dot or the polarities of the data voltage and the voltage applied to the common electrode are periodically reversed.

However, reversing the polarities of the data voltages causes a blurring phenomenon because it takes a long time for the LC capacitor to be charged to a target voltage due to the slow response time of the LC molecules. The effect is particularly noticeable in moving images.

An impulsive driving arrangement, which inserts a black image between normal images, has been utilized in an attempt to alleviate the blurring problem. The impulsive driving arrangement has been implemented using either the impulsive emission technique in which the entire screen becomes black for a predetermined time by turning off the backlight lamps or, in the cyclic resetting approach, by periodically applying black data voltages together with the normal data voltages. However, insertion of the black image during the predetermined time lowers the brightness of the screen.

### BRIEF SUMMARY OF THE INVENTION

In an exemplary embodiment of the present invention, a signal controller converts current input image data of a first frequency into first and second output image data of a second frequency and a data driver converts output image data from the signal controller into corresponding analog data voltages and sequentially applies them to the pixels, the signal controller calculating the position where a virtual image is to be displayed in a virtual frame based on input image data from a virtual frame and virtual input image data in order to generate modified current input image data.

The signal controller calculates the position of a pixel where the gray of the previous input image data and that of the current input image data are different, and predicts the position of the virtual image.

At the pixel where the virtual image is displayed, the signal controller corrects the gray of the input image data to be equal to the gray of the previous input image data as the modified current input image data.

At the pixel where the current gray and the previous gray are different, the signal controller sets the current gray as an average of the current and previous grays as the modified current input image data.

At the pixel where the current gray and the previous gray are different, the signal controller sets the current gray as an average of a certain number of adjacent pixels, including a pixel in the previous frame to generate the modified current input image data.

At a pixel where the current gray and the previous gray are the same, the signal controller sets the current gray to be the same as the previous gray as the modified current input image data.

The signal controller may include a first frame memory storing the current input image data, a second frame memory storing the previous input image data, a signal processor comparing the current input image data and the previous input image data, determining a pixel position whose a gray has been changed to determine the movement position of the image, calculating the virtual position based on the determined movement position, and modifying grays of the input image data of the pixel where the previous input image data and the current input image data are not the same and a pixel corresponding to the virtual position to generate the modified current input image data, a third frame memory storing the modified current input image data from the signal processor, a first look-up table storing first and second output image data as functions of the previous input image data, a second look-up table storing first and second output image data as functions of the modified current input image data, and a multiplexer receiving the first and second output image data from the first and second look-up tables, and selectively outputting final first and second output image data based on a field select signal.

When a field determined by the field select signal is an upper field, the multiplexer may output the first output image data transferred from the first look-up table as the final first output image data, and when the field determined by the field select signal is a lower field, the multiplexer outputs the second output image data transferred from the second look-up table as the final second output image data.

In a further exemplary embodiment of the present invention, a display device comprising a plurality of pixels, which includes a signal controller converting current input image data of a first frequency into first and second output image data of a second frequency and outputting the first and second output image data of the second frequency, and a data driver converting the respective output image data from the signal controller into corresponding analog data voltages and sequentially applying the analog data voltages to the pixels, wherein the signal controller calculates a virtual position of a pixel where a virtual image is to be displayed at a virtual frame and virtual input image data with respect to the virtual image based on previous input image data with respect to a previous frame and the current input image data with respect to a current frame in order to generate modified t current input image data with respect to the current input image data, and converts the current input image data into first and second output image data based on the previous input image data and the modified current input image data.

The signal controller may include a first frame memory storing the current input image data, a second frame memory storing the previous input image data, a signal processor comparing the current input image data and the previous input image data, determining a position of a pixel whose a gray has been changed to determine a movement position of the image, calculating the virtual position based on the determined movement position, and correcting a grays of the input image data of a pixel where the previous input image data and the current input image data are not the same and a pixel corresponding to the virtual position to generate the modified current input image data, a third frame memory storing the modified current input image data from the signal processor, a first look-up table storing first and second output image data as functions of the previous input image data, a second look-up table storing first and second output image data as functions of the modified current input image data, and a multiplexer receiving the first and second output image data from the first and second look-up tables, and selectively outputting final first and second output image data based on a field select signal.

The signal processor may calculate a position of a pixel where a gray of the previous input image data and that of the current input image data are different, and determines a movement position of an image to thereby determine the position of the virtual image.

When a pixel is a pixel where the virtual image is displayed, the signal processor may correct a gray of the input image data to be equal to the gray of the previous input image data to generate as the modified current input image data.

When a pixel is a pixel in which the first gray and the second gray are different, the signal processes may set the second gray as an average of the first and second gray to generate as the modified current input image data.

When a pixel is a pixel in which the first gray and the second gray are different, the signal processor may set the second gray as an average of the certain number of adjacent pixels including the pixel in the previous frame to generate as the modified current input image data.

When a pixel is a pixel in which the first gray and the second gray are the same, the signal processor may set the second gray of input image data to be the same as the first gray to generate as the modified current input image data.

When a field determined by the field select signal is an upper field, the multiplexer may output the first output image data transferred from the first look-up table as the final first output image data, and when the field determined by the field select signal is a lower field, the multiplexer may output the second output image data transferred from the second look-up table as the final second output image data.

The first and second output image data stored in the first look-up table may be the same as the first and second output image data stored in the second look-up table.

The gray of the first output image data may be higher than or the same as the gray of the second output image data.

### BRIEF DESCRIPTION OF THE DRAWINGS

The forgoing objects, features and advantages of the present invention may become more apparent from a reading of the following detailed description of exemplary embodiments of the present invention with reference to the accompanying drawings, in which:

FIG. 1 is a block diagram of an exemplary embodiment of an LCD according to the present invention;

FIG. 2 is an equivalent circuit schematic diagram illustrating a structure of an exemplary embodiment of a pixel of the LCD of FIG. 1 according to the present invention;

FIG. 3 is a block diagram of an exemplary embodiment of a signal controller of the LCD of FIG. 1 according to the present invention;

FIG. 4 illustrates an exemplary embodiment of data voltages corresponding to an upper output image signal and a lower output image signal for grays of input image signals sought according to the present invention;

FIG. 5(a) illustrates a reversion form of application of data voltages corresponding to the upper output image signal to the first field;

FIG. 5(b) illustrates a reversion form of application of data voltages corresponding to the lower output image signal to the second field;

FIG. 6 is a schematic block diagram of a signal controller of an LCD according to another exemplary embodiment of the present invention; and

FIG. 7 is a flow chart of a signal process of the signal controller according to another exemplary embodiment of the present invention.

### DETAILED DESCRIPTION OF THE INVENTION

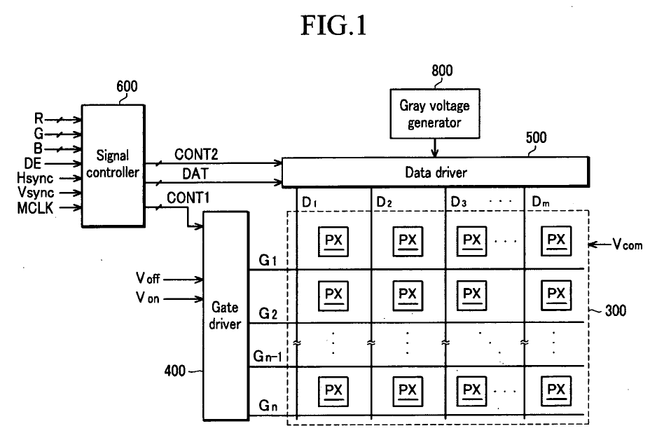

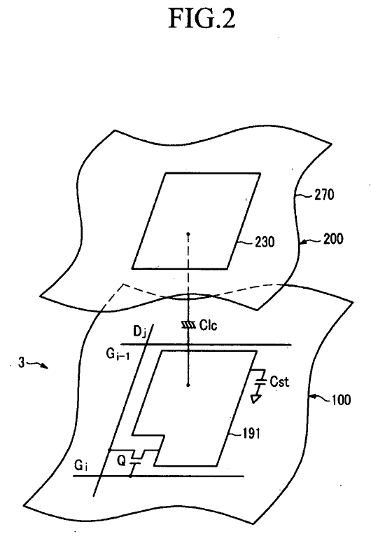

FIG. 1 is a block diagram of an exemplary embodiment of an LCD according to the present invention. FIG. 2 illustrates an equivalent circuit schematic diagram illustrating a structure of an exemplary embodiment of a pixel of the LCD of FIG. 1 according to the present invention.

Referring to FIG. 1, an exemplary embodiment of an LCD according to the present invention includes an LC panel assembly 300, a gate driver 400 and a data driver 500 connected to the LC panel assembly 300, a gray voltage generator 800 connected to the data driver 500, and a signal controller 600 for controlling the above-described elements.

Still referring to FIG. 1, the panel assembly 300 includes a plurality of signal lines G₁-Gₙ and D₁-Dₘ and a plurality of pixels PX connected to the signal lines G₁-Gₙ and D₁-Dₘ. The pixels PX are arranged substantially in a matrix. In a structural view shown in FIG. 2, the panel assembly 300 includes a lower panel 100, an upper panel 200 and an LC layer 3 interposed therebetween

Referring again to FIG. 1, the signal lines G₁-Gₙ and D₁-Dₘ include a plurality of gate lines G₁-Gₙ for transmitting gate signals (also referred to as “scanning signals”), and a plurality of data lines D₁-Dₘ for transmitting data voltages. The gate lines G₁-Gₙ extend substantially in a row direction and are substantially parallel to each other, while the data lines D₁-Dₘ extend substantially in a column direction and are substantially parallel to each other.

Referring to FIG. 2, each pixel PX, for example a pixel PX connected to an i_th gate line Gᵢ (i=1, 2, . . . , n) and a j_th data line Dⱼ (j=1, 2, . . . , m) includes a switching element Q that is connected to the signal lines G₁-Gₙ and D₁-Dₘ, and an LC capacitor Clc and a storage capacitor Cst that are connected to the switching element Q. The storage capacitor Cst may be omitted if it is unnecessary.

The switching element Q, such as a TFT, is provided on the lower panel 100 and has three terminals: a control terminal connected to one of the gate lines G₁-Gₙ; an input terminal connected to one of the data lines D₁-Dₘ; and an output terminal connected to the LC capacitor Clc and the storage capacitor Cst.

The LC capacitor Clc includes a pixel electrode 191 on the lower panel 100, a common electrode 270 on the upper panel 200 and the LC layer 3 as a dielectric between the electrodes 191 and 270. The pixel electrode 191 is connected to the switching element Q via the output terminal of the switching element Q. The common electrode 270 covers the entire surface of the upper panel 200 and is supplied with a common voltage Vcom. Alternatively, both the pixel electrode 191 and the common electrode 270, which have shapes of bars or stripes, may be provided on the lower panel 100.

The storage capacitor Cst is an auxiliary capacitor for the LC capacitor Clc. The storage capacitor Cst includes the pixel electrode 191 and a separate signal line (not shown), which is provided on the lower panel 100, which overlaps the pixel electrode 191 via an insulator, and is supplied with a predetermined voltage such as the common voltage Vcom. Alternatively, the storage capacitor Cst includes the pixel electrode 191 and an adjacent gate line called a previous gate line, which overlaps the pixel electrode 191 via an insulator.

For color display, each pixel PX uniquely represents one of three colors such as red, green, and blue colors, and may also be primary colors (spatial division), or sequentially represents the three colors in time (temporal division), thereby obtaining a desired color. FIG. 2 shows an example of the spatial division in which each pixel PX includes a color filter 230 representing one of the three colors in an area of the upper panel 200 facing the pixel electrode 191. Alternatively, the color filter 230 is provided on or under the pixel electrode 191 on the lower panel 100.

One or more polarizers (not shown) for polarizing light are attached to outer surfaces of the lower and upper panels 100 and 200 of the panel assembly 300.

Referring to FIG. 1 again, the gray voltage generator 800 generates a full number of gray voltages of a limited number of gray voltages (referred to as “reference gray voltages” hereinafter) related to the transmittance of the pixels PX. Some of the (reference) gray voltages have a positive polarity relative to the common voltage Vcom, while the other of the (reference) gray voltages have a negative polarity relative to the common voltage Vcom.

The gate driver 400 is connected to the gate lines G₁-Gₙ of the panel assembly 300 and synthesizes the gate-on voltage Von and the gate-off voltage Voff from an external device (not shown) to generate gate signals for application to the gate lines G₁-Gₙ.

The data driver 500 is connected to the data lines D₁-Dₘ of the panel assembly 300 and applies data voltages, which are selected from the gray voltages supplied from the gray voltage generator 800, to the data lines D₁-Dₘ. However, when the gray voltage generator 800 generates only a few number of the reference gray voltages other than all the gray voltages, the data driver 500 may divide the reference gray voltages to generate the data voltages among the gray voltages.

The signal controller 600 controls the gate driver 400 and the data driver 500, etc.

Each of the driving devices 400, 500, 600 and 800 may include at least one integrated circuit (“IC”) chip mounted on the LC panel assembly 300 or on a flexible printed circuit (“FPC”) film in a tape carrier package (“TCP”) type, which are attached to the panel assembly 300. Alternatively, at least one of the driving devices 400, 500, 600 and 800 may be integrated with the panel assembly 300 along with the signal lines G₁-Gₙ and D₁-Dₘ and the switching elements Q. Alternatively, all the driving devices 400, 500, 600 and 800 may be integrated into a single IC chip, but at least one of the driving devices 400, 500, 600 and 800 or at least one circuit element in at least one of the processing units 400, 500, 600 and 800 may be disposed out of the single IC chip.

Now, the operation of the above-described LCD will be described in detail.

The signal controller 600 is supplied with input image signals R, G, and B and input control signals for controlling the display thereof from an external graphics controller (not shown). The input image signals R, G and B contain luminance information of pixels PX, and the luminance has a predetermined number of grays, for example, 1024(=2¹⁰), 256(=2⁸) or 64(=2⁶) grays. The input control signals include a vertical synchronization signal Vsync, a horizontal synchronization signal Hsync, a main clock signal MCLK and a data enable signal DE, etc.

On the basis of the input control signals and the input image signals R, G and B, the signal controller 600 generates gate control signals CONT1 and data control signals CONT2 and it processes the image signals R, G and B suitable for the operation of the panel assembly 300 and the data driver 500. The signal controller 600 sends the gate control signals CONT1 to the gate driver 400 and sends the processed image signals DAT and the data control signals CONT2 to the data driver 500.

The data processing operations of the signal controller 600 include conversion of data of the input image signal R, G and B having a predetermined frequency into a plurality of, for example, two output image signals having a different frequency from the incoming input image signal, for example, double the frequency of the input image data R, G and B for output. At this time, one of two grays with respect to the two output image signals based on the grays of the input image signals has a maximum gray or minimum gray. The operations of the signal controller 600 will be described below.

The gate control signals CONT1 include a scanning start signal STV for instructing to start scanning and at least a clock signal for controlling the output time of the gate-on voltage Von. The gate control signals CONT1 may further include an output enable signal OE for defining the duration of the gate-on voltage Von.

The data control signals CONT2 include a horizontal synchronization start signal STH for informing of a start of data transmission for a group of pixels PX, a load signal LOAD for instructing to apply the data voltages to the data lines D1-Dm, and a data clock signal HCLK. The data control signal CONT2 may further include an inversion signal RVS for reversing the polarity of the data voltages (relative to the common voltage Vcom).

Responsive to the data control signals CONT2 from the signal controller 600, the data driver 500 receives a packet of the digital image signals DAT for the row of pixels PX from the signal controller 600, converts the digital image signals DAT into analog data voltages selected from the gray voltages, and applies the analog data voltages to the data lines D₁-Dₘ.

The gate driver 400 applies the gate-on voltage Von to the gate line G₁-Gₙ in response to the gate control signals CONT1 from the signal controller 600, thereby turning on the switching transistors Q connected thereto. The data voltages applied to the data lines D₁-Dₘ are then supplied to the pixels PX through the activated switching transistors Q.

The difference between the voltage of a data voltage and the common voltage Vcom applied to a pixel PX is represented as a voltage across the LC capacitor Clc of the Pixel PX, which is referred to as a pixel voltage. The LC molecules in the LC capacitor Clc have orientations depending on the magnitude of the pixel voltage, and the molecular orientations determine the polarization of light passing through the LC layer 3. The polarizer(s) converts the light polarization into the light transmittance such that the pixel PX has a luminance represented by a gray of the data voltage.

By repeating this procedure by a unit of a horizontal period (also referred to as “1H” and equal to one period of the horizontal synchronization signal Hsync and the data enable signal DE), all gate lines G₁-Gₙ are sequentially supplied with the gate-on voltage Von, thereby applying the data voltages to all pixels PX to display an image for a frame.

When the next frame starts after one frame finishes, the inversion signal RVS applied to the data driver 500 is controlled such that the polarity of the data voltages is reversed (which is referred to as “frame inversion”). The inversion signal RVS may be also controlled such that the polarity of the data voltages flowing in a data line are periodically reversed during one frame (for example, row inversion and dot inversion), or the polarity of the data voltages in one packet are reversed (for example, column inversion and dot inversion).

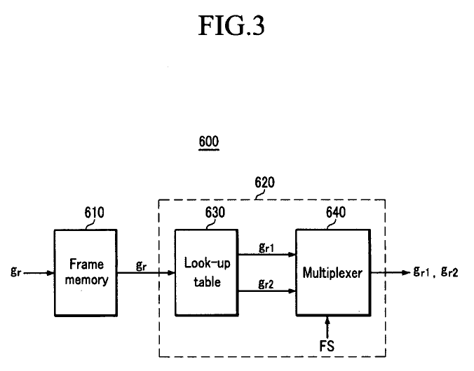

Next, the data signal processing operations of an exemplary embodiment of the signal controller 600 of an LCD according to the present invention will be described in detail with reference to FIG. 3.

Referring to FIG. 3, the signal controller 600 includes a frame memory 610 and an image signal modifier 620 connected thereto.

The frame memory 610 stores inputted image signals by frame. The image signals stored in the frame memory 610 are referred to herein as “input image data” and are denoted by “gᵣ.”

The image signal modifier 620 receives the input image data gᵣ stored in the frame memory 610 sequentially and converts each of the input image data gᵣ into a plurality of, for example, first and second output image data gᵣ₁ and gᵣ₂, for output. In detail, the image signal modifier 620 reads the input image data gᵣ once from the frame memory 610 and converts it into the first output image data gᵣ₁ for sequential output, and subsequently reads the input image data gᵣ once again therefrom and converts it into the second output image data gᵣ₂ for sequential output. After applying data voltages corresponding to the first output image data gᵣ₁ to the data lines D₁-Dₘ, the data driver 500 applies data voltages corresponding to the second output image data gᵣ₂ to the data lines D₁-Dₘ. Hereinafter, periods when the first and second output image data gᵣ₁ and gᵣ₂ are outputted and periods when the data voltage corresponding to the first and second output image data gᵣ₁ and gᵣ₂ are applied are referred to as “a field”, respectively. The periods of the two fields are 1/2 H, respectively. The image signal modifier 620 is described below in detail.

Since the input image data gᵣ stored in the frame memory 610 is read twice, a read frequency or an output frequency of the frame memory 610 is double that of a write frequency or an input frequency. Accordingly, when an input frame frequency of the frame memory 610 is 60 Hz, an output field frequency and a frequency for applying the data voltages are 120 Hz.

For the two output image data gᵣ₁ and gᵣ₂, the sum of the amount of light from the pixels by the first and second output image data gᵣ₁ and gᵣ₂ is the same as that by the input image data gᵣ before modification. As used herein, the amount of light is equal to the luminance multiplied by the time for holding the luminance.

In this case, when a luminance corresponding to the input image data gᵣ is assumed to be T(gᵣ), a luminance corresponding to the first output image data gᵣ₁ is assumed to be T(gᵣ₁) and a luminance corresponding to the second output image data T(gᵣ₂), [Equation 1] is as follows:

2T(gᵣ)=T(gᵣ₁)+T(gᵣ₂) [Equation 1]

In addition, one of tow grays Pᵣ₁ and Pᵣ₂ corresponding to the two output image data gᵣ₁ and gᵣ₂, respectively, is larger than or the same as the other. That is, Pᵣ₁≧Pᵣ₂ or Pᵣ₁≦Pᵣ₂.

An output image data having a larger gray voltage is referred to as an “upper output image data”, and an output image data having a smaller gray voltage is referred to as a “lower output image data” of the two grays Pᵣ₁ and Pᵣ₂ corresponding to the two output image data gᵣ₁ and gᵣ₂, and, at this time, the upper output image data may be output first, or the lower output image data may be output first. In this case, a field during output of the upper output image data is referred to as “an upper field”, and a field during output of the lower output image data is referred to as “a lower field”.

A light amount resulting from the lower output image data preferably does not exceed about 50% of that resulting from the upper output image data, and a gray of the lower output image data becomes 0, i.e., a black gray, or becomes near thereto so that an effect of impulsive driving is given.

An exemplary embodiment for obtaining the upper output image data and the lower output image data for satisfying the above conditions and giving the effect of the impulsive driving is described below in detail.

In the present exemplary embodiment, for Pᵣ₁≧Pᵣ₂, the first output image data gᵣ₁ having the gray Pᵣ₁ is referred to as an upper output image data and the second output image data gᵣ₂ having the gray Pᵣ₂ is referred to as a lower output image data, and the upper output image data is assumed to be output prior to the lower output image data.

When the input image data gᵣ stored in the frame memory 610 is 8 bits, the gray Pᵣ of the input image data ranges from 0 to 255, and the luminance T(gᵣ) of the input image data gᵣ having the gray Pᵣ has the following relationship.

T(gᵣ)=α(Pᵣ/255)γ

When γ=2.5 and the gray Pᵣ of the input image data gᵣ is 192, a luminance for 192 corresponds to a half of that for 255, the highest gray. Accordingly, the gray Pᵣ₁ of the upper output image data gᵣ₁ and the gray Pᵣ₂ of the lower output image data gᵣ₂ is determined as follows:

(1) if 0≦Pᵣ≦192, Pᵣ₁=(255/192)×Pᵣ₁, Pᵣ₂=0; and

(2) if 193≦Pᵣ≦255, Pᵣ₁=255, Pᵣ₂=T⁻¹[2T(Pᵣ)−T(255)].

That is, when the gray Pᵣ of the input image data gᵣ is in the range (1), the gray Pᵣ₁ is the upper output image data gᵣ₁ and is determined as the highest gray, 255, and depending on the gray Pᵣ of the input image data gᵣ, the gray Pᵣ₂ of the lower output image data gᵣ₂ is 0.

When the gray Pᵣ of the input image data gᵣ is in the range (2), the gray Pᵣ₁ of the upper output image data gᵣ₁ has the highest gray, 255, and the gray Pᵣ₂ of the lower output image data gᵣ₂ has a value satisfying Equation 1. When the gray Pᵣ of the input image data gᵣ is 255, both the gray Pᵣ₁ of the upper output image data gᵣ₁ and the gray Pᵣ₂ of the lower output image data gᵣ₂ data become 255.

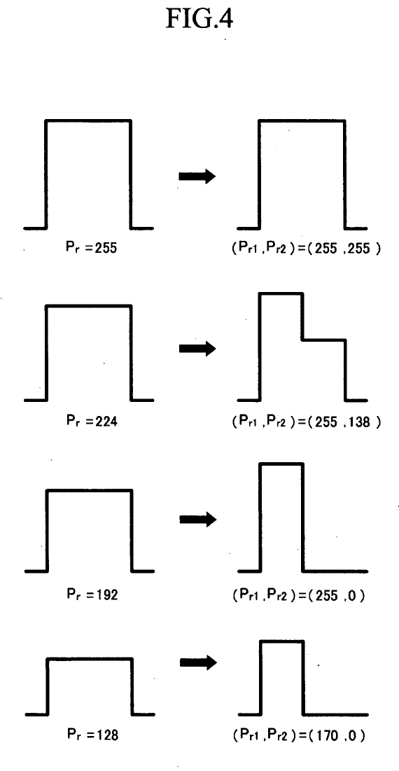

When the grays Pᵣ of the input image data gᵣ are 128, 192, 224 and 255, respective data voltages corresponding to the respective upper output image data gᵣ₁ and the respective lower output image data gᵣ₂ obtained by the relations (1) and (2) are shown in FIG. 4.

As shown in FIG. 4, on application of the data voltages corresponding to the output image data gᵣ₁ and gᵣ₂ during each field, when the gray Pᵣ of the input image data gᵣ is lower than 192, the gray Pᵣ₁ of the upper output image data gᵣ₁ is selected in a range lower than 255, the highest gray. At this time, the gray Pᵣ₁ of the upper output image data gᵣ₁ is larger than the gray Pᵣ of the input image data gᵣ. Since the data voltages corresponding to the respective output image data gᵣ₁ and gᵣ₂ are applied to the corresponding pixels during the first and second fields, the period when the data voltages corresponding to the upper or lower output image data gᵣ₁ and gᵣ₂ are applied to the pixels is reduced by about 1/2 relative to that when the data voltages corresponding to the input image data gᵣ are applied thereto. Accordingly, data voltages that are larger than the data voltages corresponding to the input image data gᵣ need to be applied to the pixels so that an amount of light that is almost the same as that resulting from the input image data gᵣ may be obtained. In this case, since only the data voltages corresponding to the upper output image data gᵣ₁ can substantially provide the light amount by the input image data gᵣ, the gray Pᵣ₂ of the lower output image data gᵣ₂ becomes 0 in order to give the impulsive driving effect.

However, when the gray Pᵣ of the input image data gᵣ exceeds 192, and in this case the gray Pᵣ₂ of the lower output image data gᵣ₂ is 0, although the gray Pᵣ₂ of the upper output image data gᵣ₁ is selected to be 255, the highest gray, a light amount that is the same as that resulting from the input image data gᵣ cannot be obtained. That is, a loss of luminance occurs. Accordingly, the gray Pᵣ₂ of the lower output image data gᵣ₂ is selected to be a value larger than 0 so that the insufficient light amount is compensated by the light amount by the lower output image data gᵣ₂. Although the gray Pᵣ₂ of the lower image data gᵣ₂ giving the impulsive driving effect is not 0, the gray Pᵣ₂ thereof has a lower gray, for example a gray near 0, and thus the impulsive driving effect is obtained to some degree.

Operation of the signal controller 600 that transmits the two output image data gᵣ₁ and gᵣ₂ obtained in this way to the data driver 500 is described below with reference to FIG. 4.

As described above, the signal controller 600 includes the frame memory 610 and the image signal modifier 620. The image signal modifier 620 includes a look-up table (“LUT”) 630 connected to the frame memory 610 and a multiplexer (“MUX”) 640 connected to the LUT 630 and receiving a field selecting signal FS. The field selecting signal FS is determined in many ways, such as odd-numbered and even-numbered fields, or by using a counter. In addition, the field selecting signal FS may be generated in the internal signal controller 600 or may be provided from an external device (not shown).

The LUT 630 of the image signal modifier 620 stores the upper output image data gᵣ₁ and the lower output image data gᵣ₂ as a function of the input image data gᵣ. Accordingly, the LUT 630 responds to the input image data gᵣ to output the upper and lower output image data gᵣ₁ and gᵣ₂ to the multiplexer 640.

The multiplexer 640 selects one of the upper and lower output image data gᵣ₁ and gᵣ₂ from the LUT 630, depending on the field selecting signal FS, for sequential output to the data driver 500.

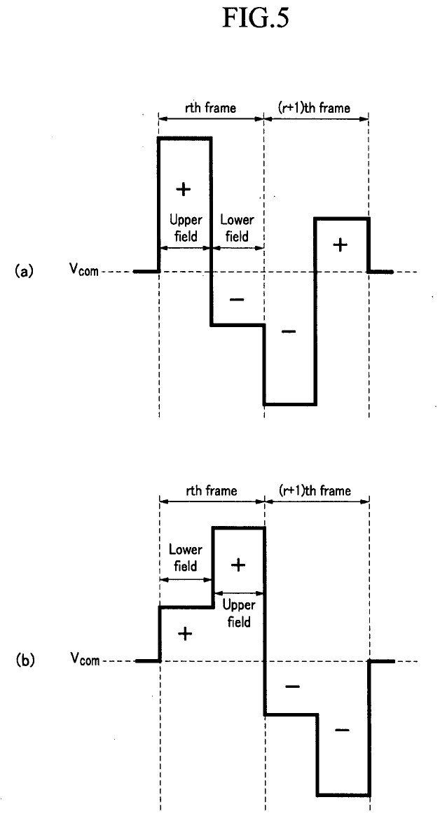

The data voltages corresponding to the upper output image data gᵣ₁ and the lower output image data gᵣ₂ applied to the pixels PX via the data lines D₁-Dₘ through the data driver 500 as described above have reversion forms as shown in FIG. 5. FIG. 5(a) illustrates the reversion form on application of the data voltages corresponding to the upper output image data gᵣ₁ to the first field, and FIG. 5(b) illustrates the reversion form on application of the data voltages corresponding to the lower output image data gᵣ₂ to the second field.

Polarities of the data voltages corresponding to the upper output image data gᵣ₁ have to be identical to those of a previous field adjacent thereto so that a charging speed of pixels PX by the upper output image data gᵣ₁ affecting images is reduced.

In addition, the polarities of the data voltages corresponding to the upper output image data gᵣ₁ have to be reversed for each frame and those of the data voltages corresponding to the lower output image data gᵣ₂ have to be reversed for each frame, and thus an average for a pixel voltage is not inclined to either a positive polarity or a negative polarity.

Accordingly, when the upper output image data gᵣ₁ is applied during the first field, the polarities of the data voltages applied during two fields are opposite to each other and those applied during adjacent frames are also opposite, and the polarity of each pixel is reversed for two fields, as shown in FIG. 5(a).

When the upper output image data gᵣ₁ is applied during the second field, the polarities of the data voltages applied during two fields within one frame are identical and those applied during two adjacent frames are opposite to each other, and each pixel is reversed for two fields, as shown in FIG. 5(b).

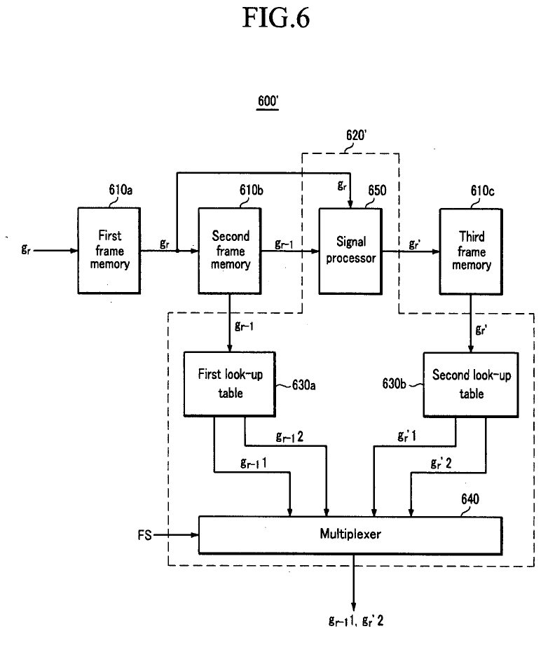

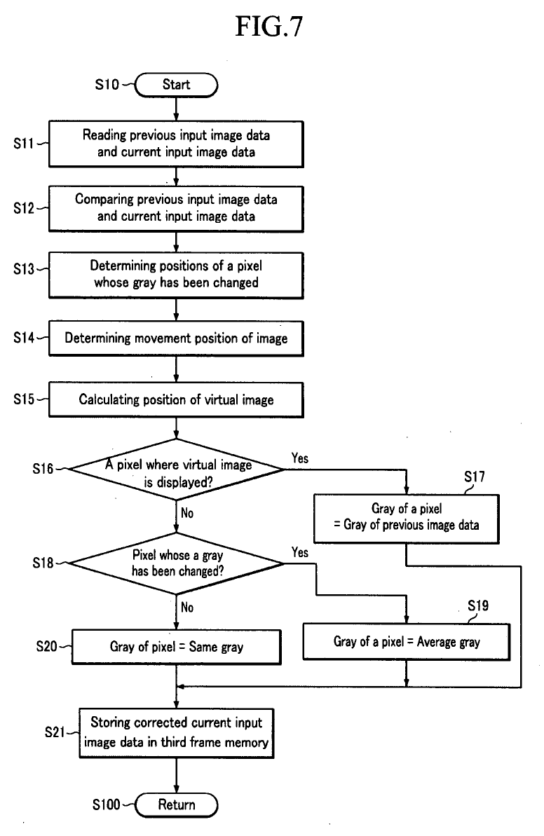

The LCD according to another exemplary embodiment of the present invention will now be described with reference to FIGS. 6 and 7.

FIG. 6 is a schematic block diagram of a signal controller of an LCD according to another exemplary embodiment of the present invention, and FIG. 7 is a flow chart of a signal process of the signal controller according to another exemplary embodiment of the present invention.

The LCD according to the present exemplary embodiment has the same structure and operation as the LCD shown in FIGS. 1 to 5(b), except for a signal controller 600′ for receiving input image signals and outputting a plurality of output image data, so only the structure and operation of the signal controller 600′ will be described in detail as follows.

As shown in FIG. 6, the signal controller 600′ includes first to third frame memories 610a to 610c and an image signal modifier 620′.

The first frame memory 610a stores input image data of a current frame (referred to hereinafter as “current input image data”) gᵣ, the second frame memory 610b stores input image data of a previous frame (referred to hereinafter as “previous input image data”) gᵣ₋₁, and the third frame memory 610c stores input image data of a new current frame (referred to hereinafter as “modified current input image data”) gᵣ′ generated by the image signal modifier 620′.

The image signal modifier 620′ includes a signal processor 650 for receiving the current input image data gᵣ and the previous input image data gᵣ₋₁ from the first and second frame memories 610a and 610b and generating the modified current input image data gᵣ′, first and second LUTs 630a and 630b for storing the upper and lower output image data gᵣ₋₁ and gᵣ₋₁2 and gᵣ′1 and gᵣ′2 with respect to the previous input image data gᵣ₋₁ and the modified current input image data gᵣ′ from the second and third frame memories 610b and 610c, and a multiplexer 640 for outputting one output image data corresponding to a pertinent field among the upper and lower output image data gᵣ₋₁ 1 and gᵣ₋₁2 and gᵣ′1 and gᵣ′2 based on the field select signal FS with respect to the inputted upper and lower output image data gᵣ₋₁1 and gᵣ₋₁2, gᵣ′1 and gᵣ′2.

The operation of the signal controller 600′ will now be described with reference to FIG. 7.

As shown in FIG. 7, the signal processor 650 reads the current input image data gᵣ of all the pixels PX of an arbitrary single frame stored in the first frame memory 620a, and previous input image data gᵣ₋₁ of all the pixels PX with respect to a previous frame stored in the second frame memory 610b (step S11).

The signal processor 650 compares grays of the previous input image data gᵣ₋₁ and the current input image data gᵣ of all the pixels and determines positions of pixels where the grays values of the two image data gᵣ₋₁ and gᵣ have been changed (steps S12 and S13).

Based on the positions of pixels with changed gray values, the signal processor 650 determines a movement position of an image that has been moved from the previous frame to the current frame (step S14). When the image is moved from the position of the previous frame to the position of the current frame, and when an image (referred to hereinafter as “virtual image”) is displayed at a frame virtually existing between the previous frame and the current frame, the signal processor 650 obtains the position (referred to hereinafter as “virtual position”) where the virtual image is displayed (step S15). For example, an approximate midway position between the position of the image positioned at the previous frame and the position of the image positioned at the current frame is determined as the virtual position where the virtual image is displayed.

Then, the signal processor 650 generates the modified current input image data gᵣ′, which have corrected the current input image data gᵣ based on the change of grays of the previous image data gᵣ₋₁ and the current input image data gᵣ and the virtual position where the virtual image is to be displayed, with respect to all the pixels PX.

First, the signal processor 650 determines whether a current pixel is a pixel of the virtual position determined at the step S15, namely, a pixel existing at the position where the virtual image is to be displayed (step S16). If the current pixel is the pixel existing at the virtual position where the virtual image is to be displayed, the signal processor 650 determines a gray of the image data with respect to the pixel as a gray of the input image data gᵣ₋₁ of the previous frame before the position of the image was changed (step S17), and stores them as the modified current input image data gᵣ′ in the third frame memory 610c (step S21).

However, if the current pixel is not the pixel existing at the virtual position where the virtual image is to be displayed, the signal processor 650 determines whether the pixel is a pixel of the image data whose a gray has been changed when the image is moved from the previous frame to the current frame (step S18).

If the current pixel is the pixel with the changed gray of image data, the signal processor 650 determines the gray of the current pixel as an average gray (step S19) and stores it as the modified current input image data gᵣ′ in the third frame memory 610 (step S21).

Namely, the average gray of the gray of the previous input image data gᵣ₋₁ and the gray of the current input image data gᵣ with respect to a corresponding pixel is calculated to be determined as the gray of the current pixel. Alternatively, an average gray of previous input image data with respect to the certain number of adjacent pixels including the corresponding pixel is obtained to be determined as the gray of the current pixel.

If, however, the current pixel is not a pixel whose gray of the image data has not been changed, the signal processor 650 determines that no change in the gray of the image data has been made. Accordingly, the signal processor 650 sustains the gray of the previous frame as the gray of the image data with respect to the current pixel, and stores it as the modified current input image data gᵣ′ in the third frame memory 610c (step S21).

In this manner, the signal processor 650 generates the modified current input image data gᵣ′ obtained by the newly modified gray of the image data with respect to all the pixel PX based on the change in the position of the images, and stores it in the third frame memory 610c.

The first and second LUTs 630a and 630b store the upper output image data gᵣ₋₁ and gᵣ′1 and the lower output image data gᵣ₋₁2 and gᵣ′2 as functions of the input image data gᵣ₋₁ and gᵣ′, and in this respect, the data values stored in the first and second LUTs 630a and 630b can be the same or different.

Accordingly, the first and second LUTs 630a and 630b output the upper and lower output of the corresponding image data gᵣ₋₁1 and gᵣ₋₁2 and gᵣ′1 and gᵣ′2 to the multiplexer 640 in response to the input image data gᵣ₋₁ and gᵣ′. In this case, the output frequency of the upper and lower output image data gᵣ₋₁1 and gᵣ₋₁2 and gᵣ′1 and gᵣ′2 is about the double the input frequency, and can be greater than double.

The multiplexer 640 selects one of the upper and lower output image data gᵣ₋₁1 and gᵣ₋₁2 and gᵣ′1 and gᵣ′2 from the first and second LUTs 630a and 630b according to a value of the field select signal (FS), and sequentially outputs it to the data driver 500. When the field determined by the field select signal FS is the upper field, the multiplexer 640 selects the upper output image data gᵣ₋₁1 outputted from the first LUT 630a and outputs it. Meanwhile, when the field determined by the field select signal FS is the lower field, the multiplexer 640 selects the upper output image data gᵣ2′ outputted from the second LUT 630b and outputs it.

Namely, in the present exemplary embodiment of the present invention, after the positions of pixels where the virtual image is positioned are determined by using the image data of the previous frame and the image data of the current frame, the image data of the previous frame is inputted to the pixels of the corresponding positions to estimate and generate a new virtual image. The lower output image data with respect to the virtual images is then transferred as the output image data with respect to the input image data to the data driver 500. Thus, because the image data with respect to the estimated virtual image is reflected on the output image data, picture quality of video can be improved.

Differently, the virtual image and the virtual position can be estimated by using a movement estimation method such as a PRA (Pel Recursive Algorithm) and a BMA (Block Matching Algorithm).

According to the present invention, when the input image data is converted into the plurality of output image data, the luminance can be improved and the effect of the impulsive driving can be obtained, and degradation of picture quality such as a residual image or a dragging phenomenon can be prevented.

In addition, after the virtual image is estimated by using the previous and current input image data, the data with respect to the virtual image is outputted as the lower output image data, so the display picture quality of motion images can be improved. Furthermore, since the lower output image data with darker luminance than luminance expressed by the upper output image data is outputted as the modified lower output image data determined based on the estimated virtual image, degradation of picture quality due to an inaccurate virtual image can be reduced.

What is claimed is:

1. A display device comprising:
a plurality of pixels;
a signal controller converting current input image data of a first frequency into first and second output image data of a second frequency; and
a data driver converting respective output image data from the signal controller into corresponding analog data voltages and sequentially applying them to the pixels,
wherein the signal controller calculates a virtual position where a virtual image is to be displayed based on input image data from a virtual frame and virtual input image data and converts the current input image data into first and second output image data based on the previous input image data and modified current input image data.

2. The device of claim 1, wherein the signal controller calculates a position of a pixel where a gray of the previous input image data and that of the current input image data are different, and determines a movement position of an image to thereby determine the position of the virtual image.

3. The device of claim 2, wherein the signal controller corrects a gray of the input image data to be equal to the gray of the previous input image data as the modified current input image data.

4. The device of claim 1, wherein when a pixel is a pixel in which the first gray and the second gray are different, the signal controller sets the second gray as an average of the first and second grays to generate as the modified current input image data.

5. The device of claim 1, wherein when a pixel is a pixel in which a first gray and a second gray are different, the signal controller sets the second gray as an average of the certain number of adjacent pixels including a pixel in a previous frame to generate the modified current input image data.

6. The device of claim 1, wherein when a pixel is a pixel in which a first gray I and a second gray are the same, the signal controller sets the second gray to be the same as the first gray to generate the modified current input image data.

7. The device of claim 1, wherein the signal controller comprises:
a first frame memory storing current input image data;
a second frame memory storing previous input image data;
a signal processor for comparing current and previous input image data, determining a position of a pixel whose a gray has been changed to determine a movement position of the image, calculating the virtual position based on the determined movement position, and modifying grays of the input image data of a pixel where the previous input image data and the current input image data are not the same and a pixel corresponding to the virtual position to generate the modified current input image data; and
a third frame memory storing the modified current input image data from the signal processor;
a first look-up table storing first and second output image data as functions of the previous input image data;
a second look-up table storing first and second output image data as functions of the modified current input image data; and
a multiplexer receiving the first and second output image data from the first and second look-up tables, and selectively outputting final first and second output image data based on a field select signal.

8. The device of claim 7, wherein when a field determined by the field select signal is an upper field, the multiplexer outputs the first output image data transferred from the first look-up table as the final first output image data, and when the field determined by the field select signal is a lower field, the multiplexer outputs the second output image data transferred from the second look-up table as the final second output image data.

9. The device of claim 8, wherein the gray of the first output image data is higher than or the same as the gray of the second output image data.

10. The device of claim 9, wherein the first and second output image data stored in the first look-up table are the same as the first and second output image data stored in the second look-up table.

11. The device of claim 1, wherein the second frequency is double the first frequency.

12. A display device comprising a plurality of pixels, comprising:
a signal controller converting current input image data of a first frequency into first and second output image data of a second frequency and outputting the first and second output image data of the second frequency; and
a data driver converting the respective output image data from the signal controller into corresponding analog data voltages and sequentially applying the analog data voltages to the pixels,
wherein the signal controller calculates a virtual position of a pixel where a virtual image is to be displayed at a virtual frame and virtual input image data with respect to the virtual image based on previous input image data and the current input image data to modify current input image data, and converts the current input image data into first and second output image data based on the previous input image data and the modified current input image data.

13. The device of claim 12, wherein the signal controller comprises:
a first frame memory storing the current input image data;
a second frame memory storing the previous input image data;
a signal processor comparing the current input image data and the previous input image data, determining a position of a pixel whose a gray has been changed to determine a movement position of the image, calculating the virtual position based on the determined movement position, and correcting a gray of the input image data of a pixel where the previous input image data and the current input image data are not the same and a pixel corresponding to the virtual position to generate the modified current input image data;
a third frame memory storing the modified current input image data from the signal processor;
a first look-up table storing first and second output image data as functions of the previous input image data;
a second look-up table storing first and second output image data as functions of the modified current input image data; and
a multiplexer receiving the first and second output image data from the first and second look-up tables, and selectively outputting final first and second output image data based on a field select signal.

14. The device of claim 13, wherein the signal processor calculates a position of a pixel where a gray of the previous input image data and that of the current input image data are different, and determines a movement position of an image to thereby determine the position of the virtual image.

15. The device of claim 13, wherein when a pixel is a pixel where the virtual image is displayed, the signal processor corrects a gray of the input image data to be equal to the gray of the previous input image data as the modified current input image data.

16. The device of claim 13, wherein when a pixel is a pixel in which the first gray and the second gray are different, the signal processes sets the second gray as an average of the first and second gray as the modified current input image data.

17. The device of claim 13, wherein when a pixel is a pixel in which the first gray and the second gray are different, the signal processor sets the second gray as an average of a certain number of adjacent pixels including the pixel in the previous frame as the modified current input image data.

18. The device of claim 13, wherein when a pixel is a pixel in which the first gray and the second gray are the same, the signal processor sets the second to be the same as the first gray as the modified current input image data.

19. The device of claim 13, wherein when a field determined by the field select signal is an upper field, the multiplexer outputs the first output image data transferred from the first look-up table as the final first output image data, and when the field determined by the field select signal is a lower field, the multiplexer outputs the second output image data transferred from the second look-up table as the final second output image data.

20. The device of claim 13, wherein the first and second output image data stored in the first look-up table are the same as the first and second output image data stored in the second look-up table.

21. The device of claim 12, wherein the gray of the first output image data is higher than or the same as the gray of the second output image data.
